(19) United States
(12) Patent Application Publication
(10) Pub. No.: US 2011/0296751 A1
(43) Pub. Date: Dec. 8, 2011

(54) SELF CONTAINED SYSTEM FOR GROWING PERENNIAL FLOWERS IN A ROCK-LIKE OR OTHER ORNAMENTAL PLANTER

(76) Inventors: Mitchell H. Stearn, Highland, NY (US); Jennifer Bright, Middle Village, NY (US)

(21) Appl. No.: 13/116,457

(22) Filed: May 26, 2011

Related U.S. Application Data
(60) Provisional application No. 61/350,682, filed on Jun. 2, 2010.

(51) Int. Cl. A01G 9/02; A01G 13/02

(52) U.S. Cl. 47/20.1; 47/66.1; 47/65.7

(57) ABSTRACT

An improved ornamental container for gardening and the like is provided. The container, which is made of an artificial material of a desired shape and size, includes soil or some other growing medium, perennial bulbs or plants, a positioning device and individual containers or planting pots made from peat moss or some other growing medium for containing the bulbs. The container of the invention includes a large opening along the top surface thereof through which the planted bulbs or flowers will grow; this opening is covered with a seal comprised of removable plastic or other material. Also provided is a plurality of holes formed along the bottom of the container for ensuring proper drainage.

This application claims the benefit of U.S. Provisional Patent Application No. 61/350,682, filed Jun. 2, 2010.

### BACKGROUND OF THE INVENTION

This invention generally relates to the field of horticulture and gardening. In particular, the present invention is directed to a preformed container for growing flowering bulbs or plants.

Flowering bulbs and plants are very popular for many indoor and outdoor applications, including gardens, landscaping and other ornamental biotic arrangements. The proper cultivation of flowering bulbs and plants requires one's attention to a number of factors. These include plant depth, protection from insects and other animals, nutrition and hydration.

Accordingly, it would be desirable to provide a system which can be of assistance in making sure bulbs are planted at the proper depth and with the proper spacing, as well as protecting bulbs from animals and providing bulbs with proper nutrition and hydration.

### SUMMARY OF THE INVENTION

An improved ornamental container for gardening and the like is provided. The container, which is made of an artificial material of a desired shape and size, includes soil or some other growing medium, perennial bulbs or plants, a positioning device and individual containers or planting pots made from peat moss or some other growing medium such as straw or coconut fiber for containing the bulbs. The container of the invention includes a large opening along the top surface thereof through which the planted bulbs or flowers will grow; this opening is covered with a seal comprised of removable plastic or other material. Also provided is at least one hole or opening formed along the bottom of the container for ensuring proper drainage.

Optionally, fertilizer in the form of spikes, which are small sticks containing compressed fertilizer, and powder can be added to the soil in the container in order to provide nutrients for aiding in the growth of plants. The fertilizer may be placed in the soil or in the container after the plants have bloomed in order to insure naturalization and repeated flowering in subsequent years. It is noted that many types of perennial flowers can be used, depending of course on the time of year, geographic location and visual presentation that is desired. The perennial bulbs or plants (of one or more varieties or types) may be preconfigured as desired within the soil to allow for different visual effects and blooming schedules.

In use, the container of the invention is unwrapped (for exposing the growing medium, with perennial plantings in place, to sun and water) after purchase, with the seal that covers the top surface opening removed, and then placed at a desirable outdoor (or even indoor) location. Water is then regularly dispensed, either through natural rainfall or manual watering depending upon placement (outdoor or indoor) of the container. No other steps are required.

Thus, the inventive system is advantageous since it does not require the purchase of separate components, soil handling, measuring or bulb planting in order for the system to be fully set up.

Importantly, the positioning device, such as a cardboard insert, is a critical part of the inventive system; its purpose is to prevent shifting of the planting pots (especially during commercial shipping) located within the soil housed within the container.

The inventive container can be used to decorate a garden, home, commercial space, or even a fire escape or rooftop within an urban landscape. Annual plants may be added to the container after perennial planting cycle has been completed as part of an overall landscaping or planter type of arrangement.

Accordingly, an object of the invention is to provide a pre-packaged potted flower arrangement.

Another object of the invention is to provide an artificial shaped container which only requires watering for purposes of setting up and maintaining the plants within the container.

Another object of the invention is to provide repeated years of flowering due to the naturalization of the perennial plantings when the container is placed out-of-doors. If placed indoors, repeated years of flowering can be achieved by moving the container to a cool, dry location after the growth cycle has finished, adding a fertilizer, and then returning the container to a desired growing location and adding water, thus recommencing growth and utility for the year to come.

Still other objects will be apparent from this description and the attached drawing.

### BRIEF DESCRIPTION OF THE DRAWINGS

For a fuller understanding, reference is made to the following drawing:

FIG. 1 is an exploded perspective cut-away view of the ornamental shaped container of the invention.

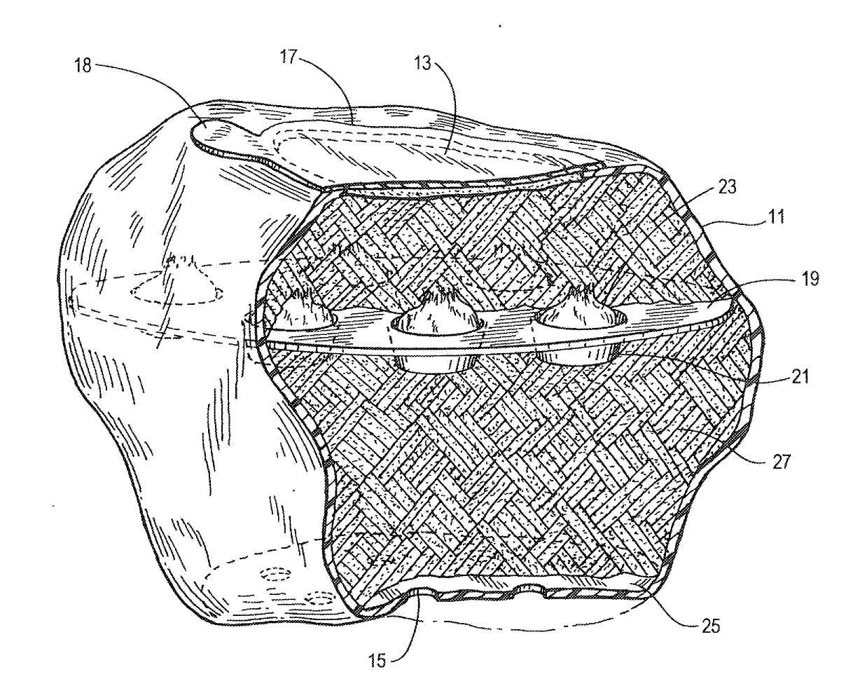

### DETAILED DESCRIPTION OF A PREFERRED EMBODIMENT

Referring to the drawings, artificial container 11 has a rock-like shape and presentation and may be made from plastic, fiberglass, an epoxy resin material or an enamel material. Container 11 includes an opening 13 formed along the top and a plurality of drainage holes 15 along the bottom. Opening 13 is provided with a removable plastic seal 17 having a pull-tab 18.

Container 11 is filled with a soil or other growing medium 27, such as vermiculite, pearlite and peat moss, or mixtures thereof. Seated approximately half-way down within the interior of container 11 is a cardboard planar insert or other positioning device 19. Insert 19 sits substantially horizontally within container 11 and abuts the sidewall of container 11 along at least a portion thereof. Insert 19 is formed with pre-formed holes or openings in which planting pots 21 are nested. Planting pots 21 are made from a growing medium such as peat moss, straw or coconut fibers (peat moss is preferred). Insert 19 ensures that pots 21 are maintained in position within the center of container 11 and well below the surface of growing medium 27. Each planting pot 21 includes one or more plant bulbs 23 such as perennial bulbs.

As stated before, fertilizer spikes or fertilizer powder may be added inside container 11 and within the soil or other growing medium 27; doing so facilitates re-blooming of the bulbs or plants.

Prior to filling the container with growing medium 27, a water-permeable paper filter 25 (such as a sheet of a paper towel) is placed over the drainage holes 15 to line the bottom of artificial rock container 11 and keep growing medium 27 in place.

Although the preformed container of the invention may have the configuration of a rock, other configurations are possible without departing from the scope of the invention.

Further, the container may be produced commercially in different colors in order to coordinate with its intended geographical and/or environmental use.

The scope of the invention will now be set forth in the following claims.

1. An ornamental shaped container comprising:
a top having an opening and a bottom with one or more holes;
wherein the ornamental container is filled with a growing medium;
wherein the container includes an insert in fixed position within said growing medium and located between said top and said bottom;
said insert supporting at least one smaller container made from a growing medium, said at least one container including one or more planting bulbs.

2. The container of claim 1, further including a removable cover located along said top.

3. The container of claim 2, wherein said cover includes a pull-tab for facilitating the removal of said cover.

4. The cover of claim 1, wherein said ornamental container growing medium is selected from soil, vermiculite, pearlite, peat moss and mixtures thereof.

5. The cover of claim 1, wherein said insert is positioned substantially halfway between said top and said bottom of said container.

6. The cover of claim 1, wherein said container has at least one side wall and said insert is fixed in position within said growing medium by abutting against at least a portion of said side wall.

7. The cover of claim 1, wherein said insert is planar in configuration.

8. The cover of claim 7, wherein said planar configured insert is fixed in position within said growing medium in a substantially horizontal orientation.

9. The cover of claim 1, wherein said insert includes at least one opening for receiving said at least one smaller container.

10. The cover of claim 1, wherein said one or more planting bulbs comprise perennial bulbs.

11. The cover of claim 1, wherein each said smaller container comprises a planting pot.

12. The cover of claim 11, wherein said planting pot is made from a growing medium that is selected from the group consisting of peat moss, straw and coconut fibers.

13. The cover of claim 1, wherein said growing medium has fertilizer added thereto.

14. The cover of claim 1, further including a water permeable filter element disposed along said bottom for preventing said growing medium from escaping said container through said one or more holes.

15. A container for growing plants comprising a top, a bottom, and at least one side wall, said container being filled with a growing medium, said container containing at least one planting pot fixed in position within said growing medium and located between said top and said bottom, each said planting pot containing one or more planning bulbs.

16. The container of claim 15, wherein said top has an opening and said bottom has a plurality of drainage holes.

17. The container of claim 15, wherein said at least one planting pot is supported along an insert.

18. The container of claim 17, wherein said insert is fixed in position within said growing medium and abuts along said at least one sidewall of said container.

19. The container of claim 18, wherein said insert is formed with at least one opening in which said at least one planting pot is nested.

20. The container of claim 15, wherein said container has a configuration in the form of a rock and is made from a material selected from plastic, fiberglass, an epoxy resin material and an enamel material.
